(19) United States
(12) Patent Application Publication
(10) Pub. No.: US 2003/0115351 A1
(43) Pub. Date: Jun. 19, 2003

(54) Digital content distribution system and method

(76) Inventor: John J. Giobbi, Northbrook, IL (US)

Correspondence Address: Michael J. Blankstein, 7358 New Washburn Way, Madison, WI, 53719, US

(21) Appl. No.: 10/016,857

(22) Filed: Dec. 14, 2001

(51) Int. Cl. G06F 15/16

(52) U.S. Cl. 709/231; 709/246

(57) ABSTRACT

A centralized digital content distribution system for use in an establishment includes a digital content server, a plurality of remote clients, and a portable remote control. The digital content server stores digital content acquired from a global computer network such as the Internet. The plurality of remote clients are located in rooms of the establishment and linked to the digital content server. The portable remote control is adapted to communicate with each of the remote clients and select the digital content stored in the digital content server.

### FIELD OF THE INVENTION

The present invention relates generally to digital content distribution and, more particularly, to a centralized digital content distribution system and method that receives digital content from a global computer network and effectively distributes the digital content to different locations in an establishment such as a residence.

### BACKGROUND OF THE INVENTION

A typical residence includes entertainment components scattered throughout various rooms of the residence. The entertainment components may, for example, include televisions, compact disc (CD) players, video disc (DVD) players, video cassette recorders (VCRs), satellite receivers, amplifiers, radios, audio speakers, game systems, etc. Also, in an entertainment room of the residence, the various components may be interconnected using complex wiring arrangements to form a home entertainment center. In addition to the aforementioned components, persons may own or rent various media, such as compact discs, DVDs, video cassettes, game cartridges, etc. When the media is not in use, the media may be scattered throughout various rooms of the residence and stored in such storage locations as entertainment units, storage cabinets, or the like. When a person wishes to play the media, the person must retrieve the media from its storage location and insert the media into the appropriate media player.

Entertainment arrangements of the above type are typically disorganized and inconvenient to their users. The entertainment components and media are scattered throughout various rooms of the residence. Wiring arrangements for interconnecting the components are often complex and confusing. Also, if a person wishes to play a particular media on a particular media player, the person must first retrieve the media from its storage location and then insert the media into the media player. This can be inconvenient especially if the media is buried in storage or if the media's storage location is in a different room than the media player.

A need therefore exists for an entertainment system and method that overcomes the aforementioned shortcomings associated with existing arrangements.

### SUMMARY OF THE INVENTION

In accordance with one aspect of the present invention, a centralized digital content distribution system for use in an establishment includes a digital content server, a plurality of remote clients, and a portable remote control. The digital content server stores digital content acquired from a global computer network such as the Internet. The plurality of remote clients are located in rooms of the establishment and linked to the digital content server. The portable remote control is adapted to communicate with each of the remote clients and select the digital content stored in the digital content server.

### BRIEF DESCRIPTION OF THE DRAWINGS

The foregoing and other advantages of the invention will become apparent upon reading the following detailed description and upon reference to the drawings in which:

FIG. 1 is a block diagram of a digital content distribution system embodying the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

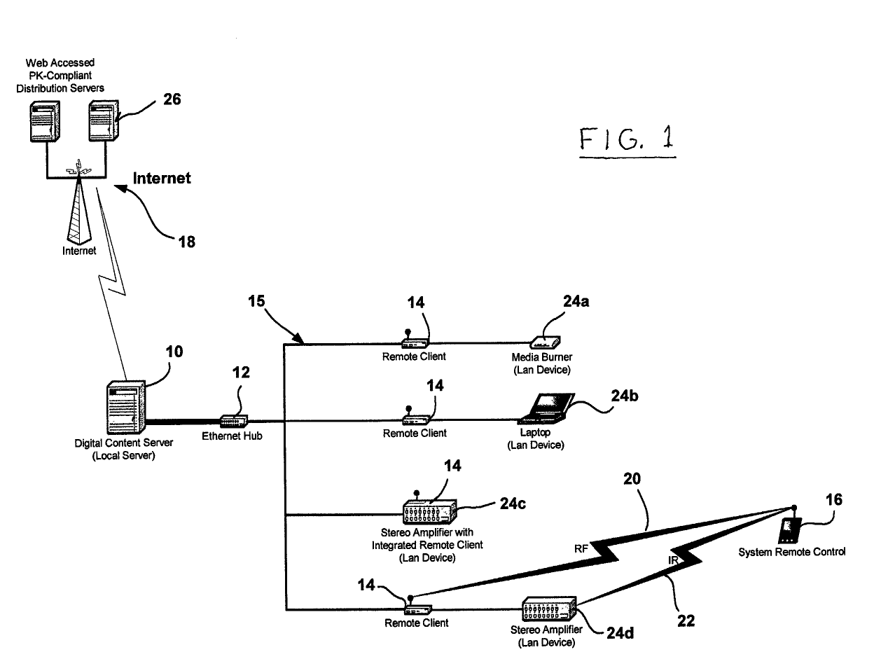

Turning now to the drawings and referring initially to FIG. 1, there is depicted a centralized digital content distribution system embodying the present invention. The system is used in an establishment such as a residence or entertainment facility. The system includes a digital content server 10, a distribution hub 12, a plurality of remote clients 14, and a portable remote control 16. The digital content server 10 stores digital content acquired from a global computer network 18 such as the Internet. In addition, the digital content server 10 may store digital content uploaded from a standard component 24. The plurality of remote clients 14 are located in different rooms of the establishment and linked to the digital content server 10 via the distribution hub 12 or via logical Ethernet addresses. The remote clients 14 are linked to the distribution hub 12 by a backbone transmission network 15. The backbone transmission network 15 may be wireless or wired with fiber optic cables, coaxial cables, or twisted pair cables, may employ a networking protocol such as Ethernet, Arcnet, or ATM (Asynchronous Transfer Mode), and may employ a communications protocol such as TCP/IP. Each remote client 14 includes a network interface card (NIC) for interfacing with the backbone transmission network 15.

The remote control 16 is adapted to communicate with each of the remote clients 14 and select the digital content stored in the digital content server 10. The remote control 16 is essentially a personal digital assistant (i.e., hand-held computer) including a display and added remote control circuitry. The display may, for example, be a liquid crystal display (LCD). The added remote control circuitry includes “system remote” circuitry and “universal remote” circuitry.

The “system remote” circuitry in the remote control 16 is for establishing a first wireless transmission link 20 with each of the remote clients 14. The first wireless transmission link 20 may be a radio link (RF) as shown or an infrared link (IR). Upon establishing the first wireless transmission link 20 with one of the remote clients 14, the remote control 16 serves as a system remote capable of (1) displaying, scanning, and selecting the digital content available on the digital content server 10 and downloading the selected digital content from the digital content server 10 to the linked remote client 14 and (2) controlling the digital content server 10 to download digital content from the global computer network 18 to the digital content server 10. As used herein, the term “download” and similar variations thereof (e.g., downloaded, downloading, etc.) is intended to cover the transfer of content from one device to a receiving device whether the content is stored on the receiving device or merely “streamed” to the receiving device for immediate playback. The remote control 16 preferably includes a display for displaying the digital content. The display may, for example, be a liquid crystal display (LCD). As a user holding the remote control 16 moves from room to room of the establishment, the remote control 16 successively establishes wireless transmission links 20 with the remote clients 14 in the respective rooms. In this way, the digital content available on the digital content server 10 follows the user's movement from room to room.

In a preferred embodiment, the first wireless transmission link 20 is a radio link established by matching transceivers in the remote control 16 and each remote client 14. The matching transceivers are preferably small, inexpensive Bluetooth™ radio chips that operate in the unlicensed ISM band at 2.4 GHz and avoid interference from other signals by hopping to a new frequency after transmitting or receiving a packet. The radio chips are plugged into the respective remote control 16 and each remote client 14, which can then communicate over short distances and through obstacles by means of radio waves. Bluetooth is a term used to describe the protocol of a short range (e.g., about 10 meters) frequency-hopping radio link between devices containing the radio chips. These devices are then termed “Bluetooth-enabled.” Further details concerning Bluetooth wireless technology may be obtained from www.bluetooth.com. Wireless technologies other than Bluetooth may be used to communicate remote control signals between the remote control 16 and each remote client 14.

The “universal remote” circuitry in the remote control 16 is for establishing a second wireless transmission link 22 with standard components 24 connected to the remote clients 14. The second wireless transmission link 22 is preferably an infrared link (IR) as shown. Upon establishing the second wireless transmission link 22 with one of the standard components 24, the remote control 16 serves as a universal remote capable of operating the standard component 24. The standard component 24 may, for example, be an audio receiver, an audiovisual receiver, a video monitor (television), etc. The standard components 24 may be physically separate from, but linked to, the respective remote clients 14 or may be physically integrated into the respective remote clients 14 like integrated device 24c.

The digital content stored on the digital content server 10 may be formatted as a compact disc (CD), digital video disc (DVD), MP3, electronic book, software, etc. When the remote control 16 is linked to one of the remote clients 14, a user may scan and select digital content to be downloaded from the digital content server 10 to the remote client 14 and converted by the remote client 14 to a standard playable format (e.g., analog format) that can be played on the associated standard component 24. The selected digital content is downloaded from the digital content server 10 to the remote client 14 as raw digital data packets. The remote client 14, in turn, converts the downloaded digital content to a standard component output(s) compatible with a standard component 24 connected to the remote client 14, and the standard component 24 plays the digital content. The standard component output(s) of the remote client 14 may, for example, include analog video jacks (e.g., standard video and S-Video), analog audio jacks (e.g., right and left audio jacks), digital audio jacks (e.g., dolby digital, PCM digital, etc.), Universal Serial Bus, serial port, Ethernet, Firewire™, or other similar outputs. The standard component 24 incorporates, or is linked to, audio speakers for broadcasting any audio signals received from the remote client 14 and a video monitor for displaying any video signals received from the remote client 14.

The digital content stored on the digital content server 10 may be encrypted, in which case the plurality of remote clients 14 include decryption circuitry for unlocking the digital content. The digital content selected for download from the digital content server 10 to a remote client 14 preferably remains encrypted until converted to a standard component output(s) in the remote client 14. To decrypt the selected digital content, the remote control 16 contains a key code initially acquired from a key provider. The digital content is initially acquired on the global computer network 18 from a content provider 26 that marks the digital content with an unlock code associated with the key code. The decryption circuitry in the remote client 14 receives the key code from the remote control 16 via the wireless transmission link 20 and is enabled to unlock and convert the digital content to a playable format if the key code is associated with the unlock code in the digital content. If the key code is not associated with the unlock code in the digital content, the remote client 14 will not unlock and convert the digital content. Further information concerning such a digital rights management system and method may be obtained from U.S. patent application Ser. No. 09/750,487 filed Dec. 27, 2000, entitled “Digital Rights Management System and Method,” and incorporated herein by reference in its entirety.

In an alternative embodiment, the remote clients 14 are eliminated and the standard components 24 are linked directly to standard component outputs of the distribution hub 12 by the backbone transmission network 15. In this case, the distribution hub 12 serves as a switch, and the digital content server 10 contains the decryption circuitry for unlocking the digital content. As the digital content is decrypted, it is converted to a playable format and fed to the distribution switch 12 for delivery to the appropriate standard component 24. As in the preferred embodiment, the decryption circuitry in the digital content server 10 receives the key code from the remote control 16 and is only enabled to unlock and convert the digital content to a playable format if the key code is associated with the unlock code in the digital content.

Instead of decrypting the digital content so that it can be played, the digital content may be downloaded (or “passed through”) in its encrypted format to a storage device such as a media burner 24a or computer hard disk 24b for storage thereon. When a user ultimately desires to play the stored digital content on a media player, the media player must contain the decryption circuitry for unlocking the digital content. After unlocking the digital content, the media player converts the unlocked digital content to a playable format and plays the digital content. The decryption circuitry in the media player receives the key code from the remote control 16 and is only enabled to unlock and convert the digital content to a playable format if the key code is associated with the unlock code in the digital content.

In addition to downloading selected digital content from the digital content server 10 to the remote clients 14, data (e.g., MP3, CD, DVD, software, etc.) from the standard components 24 can be uploaded to the digital content server 10 and stored digitally thereon. This allows for storage of legacy content on the digital content server 10.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

1. A centralized digital content distribution system for use in an establishment, comprising:
a digital content server for storing digital content acquired from a global computer network;
a plurality of remote clients located in rooms of the establishment and linked to the digital content server; and
a portable remote control for communicating with each of the remote clients and selecting the digital content stored in the digital content server.

2. The system of claim 1, wherein the selected digital content is downloaded from the digital content server to one of the remote clients and converted by the remote client to a playable format.

3. The system of claim 2, wherein the playable format is compatible with a standard component connected to the remote client.

4. The system of claim 1, wherein the digital content server converts the selected digital content to a playable format compatible with a standard component coupled to the digital content server.

5. The system of claim 1, wherein the remote clients are linked to the digital content server via a distribution hub, and the remote clients are linked to the distribution hub by a backbone transmission network.

6. The system of claim 1, wherein the remote control includes means for establishing a first wireless transmission link with each of the remote clients.

7. The system of claim 6, wherein the remote control is enabled to display and select the digital content available on the digital content server upon establishing the first wireless transmission link with one of the remote clients.

8. The system of claim 7, wherein the remote control includes a display for displaying the digital content available on the digital content server.

9. The system of claim 6, wherein the first wireless transmission link is selected 5 from a group consisting of a radio link and an infrared link.

10. The system of claim 6, wherein the remote control includes means for establishing a second wireless transmission link with standard components connected to the remote clients.

11. The system of claim 10, wherein the remote control is adapted to control the standard components upon establishing the second wireless transmission link with the standard components.

12. The system of claim 1, wherein the digital content is encrypted and at least one of the digital content server and the plurality of remote clients includes decryption circuitry for unlocking the digital content.

13. The system of claim 12, wherein the remote control contains a key code, and wherein the decryption circuitry receives the key code from the remote control and unlocks the digital content if the key code is associated with an unlock code in the digital content.

14. The system of claim 1, wherein one or more of the remote clients are integrated into respective standard components.

15. The system of claim 1, wherein the remote control is adapted to control the digital content server to acquire the digital content from the global computer network.

16. The system of claim 16, wherein the remote control is adapted to sort and categorize the digital content on the digital content server.

17. The system of claim 1, wherein the digital content is formatted as a compact disc (CD), digital video disc (DVD), MP3, electronic book, or software.

18. A centralized digital content distribution method for use in an establishment, comprising:
storing digital content acquired from a global computer network at a digital content server;
positioning a plurality of remote clients in rooms of the establishment and linking the remote clients to the digital content server; and
selecting the digital content stored at the digital content server by communicating with one of the remote clients with a remote control.

19. The method of claim 18, further including downloading the selected digital content from the digital content server to one of the remote clients and converting the downloaded digital content to a playable format.

20. The method of claim 19, wherein the playable format is compatible with a standard component connected to the remote client.

21. The method of claim 18, further including converting, at the digital content server, the selected digital content to a playable format compatible with a standard component coupled to the digital content server.

22. The method of claim 18, wherein the step of positioning a plurality of remote clients in rooms of the establishment and linking the remote clients to the digital content server includes linking the remote clients to the digital content server via a distribution hub and linking the remote clients to the distribution hub by a backbone transmission network.

23. The method of claim 18, further including establishing a first wireless transmission link between the remote control and one of the remote clients.

24. The method of claim 23, farther including enabling the remote control to display and select the digital content available on the digital content server upon establishing the first wireless transmission link between the remote control and one of the remote clients.

25. The method of claim 24, further including displaying the digital content available on the digital content server on a display of the remote control.

26. The method of claim 23, wherein the first wireless transmission link is selected from a group consisting of a radio link and an infrared link.

27. The method of claim 23, further including establishing a second wireless transmission link between the remote control and a standard component connected to one of the remote clients.

28. The method of claim 27, farther including controlling the standard component with the remote control upon establishing the second wireless transmission link between the remote control and the standard component.

29. The method of claim 18, wherein the digital content is encrypted and at least one of the digital content server and the plurality of remote clients includes decryption circuitry for unlocking the digital content.

30. The method of claim 29, wherein the remote control contains a key code, and wherein the decryption circuitry receives the key code from the remote control and unlocks the digital content if the key code is associated with an unlock code in the digital content.

31. The method of claim 18, farther including controlling the digital content server with the remote control to acquire the digital content from the global computer network.

32. The method of claim 31, wherein the step of controlling the digital content server with the remote control includes controlling the digital content server to sort and categorize the digital content on the digital content server.

33. A centralized digital content distribution system for use in an establishment, comprising:
a digital content server for storing digital content acquired from a global computer network and converting the digital content to a playable format;
a plurality of remote standard components located in rooms of the establishment and linked to the digital content server; and
a portable remote control for communicating with each of the standard components and selecting the digital content to be converted by the digital content server to the playable format.

34. The system of claim 33, wherein the digital content is encrypted and the digital content server includes decryption circuitry for unlocking the digital content.

35. The system of claim 34, wherein the remote control contains a key code, and wherein the decryption circuitry receives the key code from the remote control and unlocks the digital content if the key code is associated with an unlock code in the digital content.
